(19) United States
(12) Patent Application Publication
(10) Pub. No.: US 2024/0351030 A1
(43) Pub. Date: Oct. 24, 2024

(54) Microfluidic Devices with Reusable Components

(71) Applicant: TDK Corporation, Tokyo (JP)

(72) Inventor: Rakesh Sethi, San Jose, CA (US)

(73) Assignee: TDK Corporation, Tokyo (JP)

(21) Appl. No.: 18/634,178

(22) Filed: Apr. 12, 2024

Related U.S. Application Data
(60) Provisional application No. 63/460,150, filed on Apr. 18, 2023.

(51) Int. Cl. B01L 3/00

(52) U.S. Cl. CPC B01L 3/502715; B01L 3/50273; B01L 2300/0627; B01L 2300/12; B01L 2400/0475

(57) ABSTRACT

An example microfluidic device includes a first substrate, a second substrate, a set of electrodes, a set of piezoelectric components, a support, a set of piezoelectric actuators coupled to the support, and a polymer component. In the example device, the set of electrodes and the set of piezoelectric components are coupled to a surface of the second substrate. The support is configured to support at least one of the first substrate and the second substrate. The set of piezoelectric actuators is configured to adjust positioning of the support. The polymer is adapted to removably couple the first and second substrates such that a microfluidic channel is formed between the first and second substrates while the first and second substrates are coupled by the polymer.

### PRIORITY AND RELATED APPLICATIONS

This application claims priority to U.S. Provisional Patent Ser. No. 63/460,150, filed Apr. 18, 2023, entitled “Disposable cartridge microfluidic chip with reusable pump and impedance probes,” which is incorporated by reference herein in its entirety.

### TECHNICAL FIELD

This application relates generally to microfluidic devices, including but not limited to microfluidic devices with reusable components.

### BACKGROUND

Microfluidic devices allow for electrical and/or optical sensing of cells or other particles. The microfluidic aspect of the devices can allow for precise flow control. Some microfluidic devices have integrated actuators to control flow and electrodes to apply electric fields. However, conventional microfluidic devices are single-use, disposable devices that increase disposable waste. Such devices can get contaminated under study despite multiple washes. This leads to excessive waste that goes against the sustainability design principles.

### SUMMARY

The present disclosure describes microfluidic devices with reusable components, such as pumps, electrodes, actuators, and impedance probes. The present disclosure also describes methods of constructing and using such devices. Thus, the devices and methods described herein address the challenges associated with using disposable, single-use devices.

Some microfluidic devices include two substrates (e.g., each substrate with its own sets of components) coupled together to form a microfluidic channel between them. For example, a microfluidic device may include a first substrate having an outlet (e.g., a plurality of outlets), a second substrate having an inlet, and a coupling material (e.g., a bonding layer optionally composed of an adhesive material) that couples the first and second substrates such that a microfluidic channel is formed between them. In some implementations, the first and/or second substrate has actuators, electrodes, and/or other components attached/mounted thereon. As described above, in conventional use, such microfluidic devices would be single-use, disposable devices.

An example microfluidic device that includes a first substrate (e.g., a transparent/translucent material such as glass), a second substrate (e.g., a silicon material), a set of electrodes (e.g., to detect sample properties) coupled to the second substrate, a set of piezoelectric components (e.g., to control sample movement) coupled to the second substrate, and a bonding layer (e.g., a polymer). In accordance with some embodiments, the bonding layer is adapted to removably couple the first and second substrates, such that, after use, the first and second substrates can be detached (e.g., and at least one of the substrates and the components thereon may be reused).

In accordance with some embodiments a microfluidic device includes: (i) a first substrate; (ii) a second substrate; (iii) a first set of electrodes and a set of piezoelectric components coupled to a first surface of the second substrate; (iv) a support configured to support at least one of the first substrate and the second substrate; (v) a set of piezoelectric actuators coupled to the support and configured to adjust positioning of the support; and (vi) a polymer (or other type of bonding layer) adapted to removably couple the first and second substrates, where a microfluidic channel is formed between the first and second substrates while the first and second substrates are coupled by the polymer.

In accordance with some embodiments a method of operating a microfluidic device includes: (i) aligning a first substrate with a second substrate; (ii) while the first substrate is aligned with the second substrate, coupling the first substrate with the second substrate to form a microfluidic (e.g., using a bonding layer); (iii) sensing one or more parameters of the microfluidic channel using a sensing solution in the microfluidic channel; (iv) in accordance with the one or more parameters meeting one or more criteria, inputting a fluidic into the microfluidic channel via an inlet channel; (v) sensing one or more properties of the fluidic sample (e.g., the impedance of the particles of the sample fluid) while the fluidic sample is in the microfluidic channel; (vi) ejecting the fluidic sample from an outlet channel; (vii) cleaning the microfluidic channel using a cleaning solution (e.g., a saline solution); and (viii) separating the first substrate from the second substrate.

Thus, the disclosed devices and methods relate to aligning, coupling, using, cleaning, decoupling, and reusability of microfluidic device components. Such a microfluidic device provides reliable cell or particle capture, localization, and analysis. The disclosed devices and methods may replace, or complement, conventional devices and methods.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIGS. 1A-1B illustrate example microfluidic devices for flow control and measurement of cells or particles in accordance with some embodiments.

FIGS. 2A-2B illustrate example microfluidic devices including a reusable component and a disposable component, in accordance with some embodiments.

FIGS. 3A-3C illustrate an example method of operating a microfluidic device including a reusable component and a disposable component in accordance with some embodiments.

FIG. 4 is a block diagram illustrating example components of a microfluidic device in accordance with some embodiments.

FIG. 5 is a flow diagram illustrating an example method of operating a microfluidic device in accordance with some embodiments.

In accordance with common practice, the various features illustrated in the drawings are not necessarily drawn to scale, and like reference numerals can be used to denote like features throughout the specification and figures.

### DESCRIPTION OF EMBODIMENTS

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

As mentioned above, the microfluidic devices described herein allow for electrical and/or optical sensing of one or more cells (or other particles). The microfluidic aspect of the devices allows for precise flow control (e.g., using electrodes and/or piezoelectric components). A microfluidic chip may have integrated piezoelectric components (e.g., piezoelectric membranes) built on a substrate (e.g., silicon or silicon on insulator (SOI)) with electrodes to drive the piezoelectric components and/or to apply electric fields. The piezoelectric components allow for additional integrated functions such as cell sorting (e.g., after the cell signatures are captured). In some embodiments where the substrate is composed of silicon, the electrodes may be deposited (e.g., in various aspect ratios) in proximity to one another (e.g., allowing handling various sample types and sample heterogeneity). An example piezoelectric component (e.g., a MEMS piezoelectric layer) having an outlet channel (e.g., a nozzle) allows direct ejection (e.g., jetting) of cells (e.g., after they have been processed). The substrate and attached components may be bonded to second substrate (e.g., glass or plastic) to form the fluidic channel for the device. As described herein, the two substrates may be separable such that at least one of the substrates (and attached components) may be reused. For example, the bottom substrate may be detached from the top substrate and then attached to a different top substrate for subsequent use.

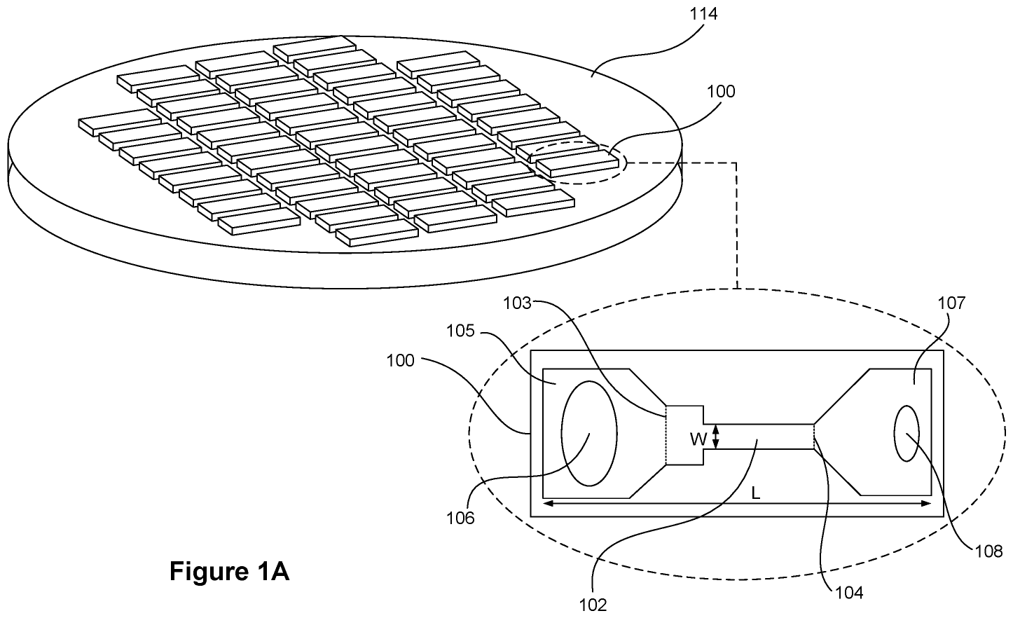

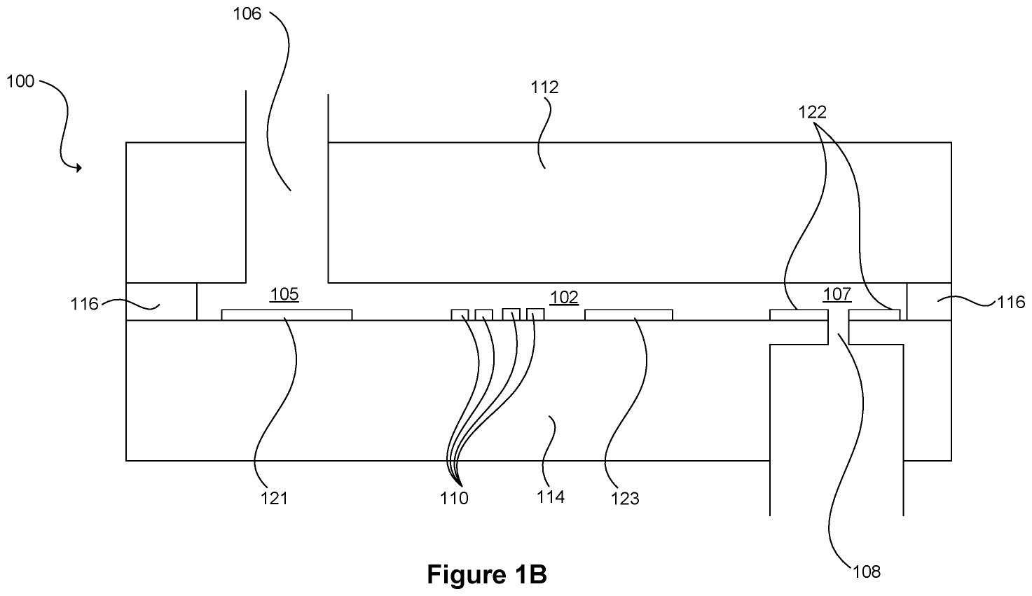

FIG. 1A illustrates a plurality of microfluidic devices (including the microfluidic device 100) on a substrate 114 in accordance with some embodiments. The microfluidic device 100 includes a fluid channel 102 (e.g., a microfluidic channel). In some embodiments, the fluid channel 102 is formed by coupling a substrate 112 (FIG. 1B) having an indentation, recess, or notch with the substrate 114 such that the fluid channel 102 is defined between the substrate 112 and the substrate 114. In some embodiments, the fluid channel 102 is further defined by a bonding layer 116 (FIG. 1B). In some embodiments, the bonding layer 116 is configured to removably couple the substrate 112 and the substrate 114 to define the fluid channel 102 (e.g., the bonding layer 116 is configured to temporarily attach the substrate 112 to the substrate 114). In some embodiments, the substrate 114 comprises a plurality of partial fluid channels (e.g., each configured to bond with a second substrate, as illustrated in FIG. 1A). For example, each partial microfluidic channel may be aligned and connected to the substrate 112 in turn to perform a plurality of sensing operations. In some embodiments, a composition, type, and/or configuration of the substrate 112 is selected based on an intended use for the microfluidic device (e.g., based on a type of fluid to be used in the microfluidic device).

In some embodiments, the microfluidic device 100 has an inlet end 103 and an outlet end 104, located at opposite ends of the fluid channel 102. The locations of the inlet end 103 and the outlet end 104 shown with respect to the fluid channel 102 in FIG. 1A are mere examples. The inlet end 103 and the outlet end 104 of the fluid channel 102 may be defined at any other location along the length dimension of the fluid channel 102 or the microfluidic device 100. In some embodiments, a length of the fluid channel 102, denoted as “L” in FIG. 1A, is in the range of 1 millimeter (mm) to 50 mm (e.g., measured from the inlet end 103 to the outlet end 104). In some embodiments, a width (e.g., a representative portion, which may be the narrowest portion) of the fluid channel 102, denoted as “W” in FIG. 1A, is selected and/or configured based on the size of a sample (e.g., a particle or cell) to be analyzed. For example, for cellular measurements, the width of the fluid channel 102 may be selected and/or configured to be on the order of the size of a cell such that only a single cell is detected/measured at a time. In some embodiments, the width of the fluid channel 102 is in the range of 10 microns (μm) to 100 μm (e.g., 50 μm). In some embodiments, the fluid channel 102 includes one or more portions that have a width different from the representative width (e.g., W in FIG. 1A). For example, as shown in FIG. 1A, the fluid channel 102 may include portions of protruding shapes such that widths of the portions are greater than the width W. Similarly, the fluid channel 102 may include one or more portions with widths narrower than the width W. In some circumstances, the wider the fluid channel 102, the slower the velocity of the particles flowing in the corresponding portion of the fluid channel 102 (e.g., when the fluid channel 102 has a uniform height), and the narrower the fluid channel 102, the higher the velocity of the particles flowing in the corresponding portion of the fluid channel 102. For example, a wider portion is used to reduce the velocity of the particles (e.g., immobilize the particles), e.g., to allow more time for analyzing the particles.

The microfluidic device 100 further includes an input region 105 for receiving, e.g., at an inlet channel 106, a sample fluid with particles (e.g., cells) to the microfluidic device 100 and providing the sample fluid to the fluid channel 102 via the inlet end 103. The microfluidic device 100 further includes an output region 107 for collecting at least a portion of the sample fluid from the fluid channel 102 via the outlet end 104 and ejecting or delivering the sample fluid portion via an outlet channel 108 (e.g., a nozzle) for further processing or analysis. In some embodiments, output region 107 is adapted to eject the sample fluid out of the microfluidic channel via the outlet end 104. For example, a size of the outlet end 104 and a size of the particles in the sample fluid may be of a same order of magnitude. In some embodiments, the diameter of the outlet channel 108 is in the range of 60 μm to 120 μm. In some embodiments, the microfluidic device 100 includes a plurality of outlet channels. For examples, samples (e.g., cells and/or particles) may be sorted within the microfluidic device 100 and directed to different outlet channels.

FIG. 1B illustrates a cross-sectional view of the microfluidic device 100, in accordance with some embodiments. As discussed above with reference to FIG. 1A, the microfluidic device 100 includes the substrate 112 (e.g., a first substrate), the substrate 114 (e.g., a second substrate), the bonding layer 116, the fluid channel 102 (e.g., defined by the substrate 112, the substrate 114, and the bonding layer 116), the inlet channel 106 (e.g., defined in the substrate 112), and the outlet channel 108 (e.g., defined in the substrate 114). In some embodiments, the substrate 112 and/or the substrate 114 include a plurality of sub-layers. In some embodiments, the inlet channel 106 is defined in the substrate 114. In some embodiments, the outlet channel 108 is defined in the substrate 112. For example, both the inlet channel and the outlet channel for the microfluidic device may be in the same substrate in some embodiments. In some embodiments, the fluid channel 102 has a height between 10 μm and 1 mm (e.g., 10 μm, 50 μm, 100 μm, 200 μm, 900 μm, 1 mm, or within a range between any two of the aforementioned values). In some embodiments, the substrate 112 has a thickness between 500 μm and 2 mm (e.g., 500 μm, 1 mm, 2 mm, or within a range between any two of the aforementioned values). In some embodiments, the substrate 114 has a thickness between 500 μm and 2 mm (e.g., 500 μm, 1.5 mm, 2 mm, or within a range between any two of the aforementioned values).

In some embodiments, the substrate 112 is a single-use substrate (e.g., a disposable substrate), and the substrate 114 is a reusable substrate (e.g., the substrate 114 is configured to be used multiple times with different first substrates). In some embodiments, the substrate 112 is composed of a transparent, translucent, or clear material (e.g., glass and/or plastic). In some embodiments, a plurality of partial microfluidic channels are defined in the substrate 112, e.g., with each partial microfluidic channel a having a separate inlet channel. For example, the substrate 112 includes a number of disposable partial channel components, and each partial microfluidic channel may be aligned and connected to the substrate 114 to perform a sensing operation.

In some embodiments, the substrate 112 and the substrate 114 are comprised of distinct materials. For example, the substrate 112 may be a glass material and the substrate 114 may be a silicon-on-insulator (SOI) substrate. In some embodiments, a composition of the substrate 112 is selected based on a use of the microfluidic device 100 (e.g., based on a type of sample fluid to be used in the microfluidic device 100 and/or a type of analysis to be performed (e.g., electrical or optical)). In some embodiments, the substrate 114 is a composed of a silicon material. In some embodiments, the substrate 114 comprises a support substrate. In some embodiments, a composition of the substrate 114 is selected based on a use of the microfluidic device 100 (e.g., based on a type of sample fluid to be used in the microfluidic device 100).

In some embodiments, the bonding layer 116 is composed of a polymer (e.g., polydimethylsiloxane (PDMS)). In some embodiments, the bonding layer 116 is adapted and/or positioned to adhere the substrate 112 and the substrate 114 to one another. For example, if the bonding layer 116 is not included, then the substrate 112 may not bond to the substrate 114 (and/or the fluid channel may not be properly formed). In some embodiments, the bonding layer 116 is adapted to form a fluidic seal for the fluid channel 102 while coupling the substrate 112 and the substrate 114. In some embodiments, the bonding layer 116 is configured to connect the substrate 112 and the substrate 114 while a given set of conditions are present (e.g., temperature and/or pressure conditions). For example, the bonding layer 116 may be a sticky polymer adapted to temporarily stick to the substrate 112 and/or the substrate 114. In some embodiments, the bonding layer 116 is configured to couple the substrate 112 and the substrate 114 while a particular pressure is applied. For example, the bonding layer 116 is bonded to the substrate 112 and adapted to attach to the substrate 114 while being pressed into the substrate 114. In some embodiments, the bonding layer 116 attaches to the substrate 114 while an electrical force and/or a mechanical force is present on the microfluidic device 100. In some embodiments, the bonding layer 116 is adapted to couple to the substrate 112 and the substrate 114 while subject to a set of conditions and the bonding layer 116 is adapted to detach from the substrate 112 and/or the substrate 114 when not subjected to the set of conditions. In some embodiments, the set of conditions include pressure, temperature, an electrical current, an electrical field, and/or a magnetic field being applied to the bonding layer 116 in particular ranges. For example, the bonding layer 116 may be adapted to detach from the substrate 112 in accordance with an electrical and/or mechanical force applied to the bonding layer 116 being reduced. In some embodiments, the bonding layer 116 is a programmable adhesive (e.g., silicotungstic acid (SiW)-complexed R32 protein hydrogels).

In some embodiments, the bonding layer 116 is composed of a photo-imagable material. For example, imaging the bonding layer 116 provides definition of the fluid channel 102, such as its width, height, and curvature (e.g., which can improve the signal-to-noise ratio (SNR) for single cell sensing). In some embodiments, the bonding layer 116 is adapted and/or positioned to provide stress relief for the substrate 112 and the substrate 114 (e.g., to prevent stress cracking when the chip is assembled in a package). In some embodiments, the bonding layer 116 is cured/hardened (e.g., submitted to multiple stages of curing/hardening). In some embodiments, the bonding layer 116 is composed of a liquid or a dry film. The bonding layer 116 may be a negative or positive photo-resist. In some embodiments, the bonding layer 116 is composed of an epoxy (e.g., bisphenol-A) and/or polyimides with photo initiators (e.g., added to drive cross linking based on the wavelength of light).

In some embodiments, the input region 105 includes a set of (one or more) piezoelectric components 121 (e.g., piezoelectric actuators and/or membranes) located adjacent to the inlet channel 106 and configured to mix the sample fluid and/or dissociate particles of the sample fluid. In some embodiments, the output region 107 includes a set of (one or more) piezoelectric components 122 (e.g., piezoelectric actuators and/or membranes) located adjacent to the outlet channel 108 configured to eject a portion of the sample fluid from the fluid channel 102. In some embodiments, the set of piezoelectric components 122 is arranged to at least partially enclose the outlet end 104 (e.g., in a ring or torus around the outlet). In some embodiments, the set of piezoelectric components 122 is configured to obstruct and/or open the outlet channel 108. In some embodiments, the microfluidic device 100 further includes a set of piezoelectric components 123 (e.g., piezoelectric actuators and/or membranes) for manipulating one or more particles of the sample fluid flowing through the fluid channel 102. In some embodiments, the set of piezoelectric components 123 is configured to sense one or properties of the sample fluid flowing through the fluid channel 102. As illustrated in FIG. 1B, the set of piezoelectric components 123 may be positioned in the fluid channel 102 between the input region 105 and the output region 107 (e.g., the inlet channel 106 may be located in an upstream region of the fluid channel 102, the outlet channel 108 may be located in a downstream region of the fluid channel 102, and the set of piezoelectric components 123 may be located in a midstream region of the fluid channel 102).

In some embodiments, the set of piezoelectric components 121, the set of piezoelectric components 122, and/or the set of piezoelectric components 123 includes one or more piezoelectric actuators (e.g., a piezo micro-electro-mechanical system (MEMS) actuator). In some embodiments, the set of piezoelectric components 121, the set of piezoelectric components 122, and the set of piezoelectric components 123 each includes two or more piezoelectric actuators. In some embodiments, the one or more of the piezoelectric actuators is arranged on a membrane. In some embodiments, the membrane is composed of a thin layer of the substrate 114 (e.g., with a thickness in the range of 1 μm to 5 μm). In some embodiments, each of the piezoelectric components is composed of one or more thin films. Each thin film may have a length in a range of 0.1 mm to 10 mm and a width in a range of 0.01 mm to 1 mm (e.g., a length of 1 mm and a width of 0.5 mm). In some embodiments, the piezoelectric elements described herein are composed of lead zirconate titanate (PZT) and/or any of the BKT-BMT-BFO set. For example, KNN such as (K0.5Na0.5)NbO3, BKT such as (Bi0.5K0.5)TiO3, BMT such as Bi(Mg0.5Ti0.5)O3, BFO such as BiFeO3, BNT such as (Bi0.5Na0.5)TiO3, and/or BT such as BaTiO3.

In some embodiments, the set of piezoelectric components 121, the set of piezoelectric components 122, and the set of piezoelectric components 123 each include a layer of piezoelectric material that is located over the substrate 114 (e.g., as illustrated in FIG. 1B). In some embodiments, the set of piezoelectric components 121, the set of piezoelectric components 122, and the set of piezoelectric components 123 each include one or more contacts coupled to the layer of piezoelectric material (e.g., for supplying electrical current to the piezoelectric material). In some embodiments, the set of piezoelectric components 121, the set of piezoelectric components 122, and the set of piezoelectric components 123 each include one or more electrodes coupled to the one or more contacts. In some embodiments, the one or more electrodes are each composed of an electrically conductive material (e.g., copper, aluminum, or gold). In some embodiments, a piezoelectric layer is positioned on a silicon-on-insulator (SOI) layer. In some embodiments, the silicon-on-insulator (SOI) layer is connected to the one or more of the contacts. In some embodiments, the layer of piezoelectric material has a thickness between 0.1 μm and 100 μm (e.g., 0.1 μm, 1 μm, 10 μm, 100 μm, or within a range between any two of the aforementioned values). In some embodiments, the outlet channel 108 has a diameter between 2 μm and 500 μm (e.g., 2 μm, 10 μm, 50 μm, 100 μm, 500 μm, or within a range between any two of the aforementioned values).

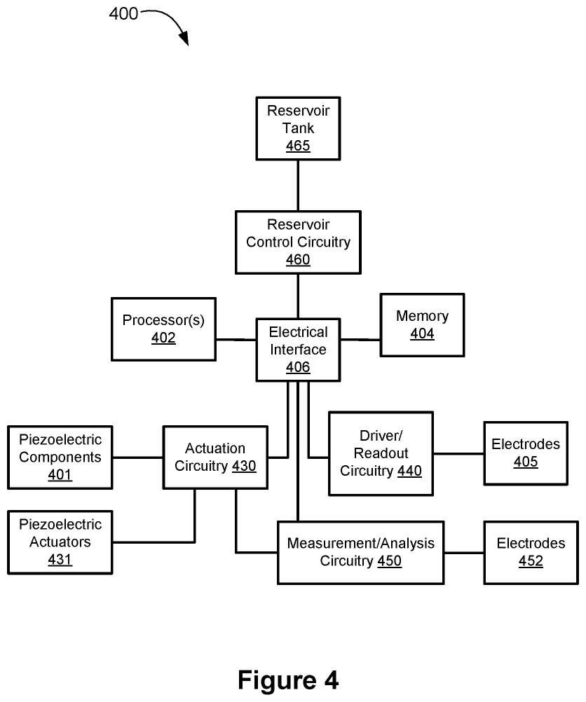

In some embodiments, the microfluidic device 100 includes actuation circuitry (e.g., actuation circuitry 430 described with respect to FIG. 4) electrically coupled to the set of piezoelectric components 121, the set of piezoelectric components 122, and/or the set of piezoelectric components 123. In some embodiments, upon application of an electrical signal from the actuation circuitry, the set of piezoelectric components 121, the set of piezoelectric components 122, and/or the set of piezoelectric components 123 generate oscillations that create displacement as well as acoustic waves, which controls localized inertial movement of the particles in the fluid channel 102 in three-dimensions (e.g., x, y, and z planes) with sub-micron level control. In some configurations, the sample fluid flows through the fluid channel 102 at a rate between 1 μL/min and 1 mL/min. In some embodiments, the set of piezoelectric components 121, the set of piezoelectric components 122, and the set of piezoelectric components 123 induce a laminar flow from the input region 105 toward the output region 107. In some embodiments, when activated using an appropriate electrical signal from the actuation circuitry, the set of piezoelectric components 123 is configured for deflecting charged particles (which have been manipulated using an electrical field generated by the at least one set of electrodes 110).

In accordance with some embodiments, the microfluidic device 100 further includes at least one set of electrodes 110 (e.g., two pairs of electrodes, as illustrated in FIG. 1B). In some embodiments, the at least one set of electrodes 110 includes a set of charging electrodes configured to charge particles flowing through the fluid channel 102 such that the particles can be manipulated with an electrical field. In some embodiments, the at least one set of electrodes 110 include a set of sensing electrodes configured to detect electrical signals of particles (e.g., cells) flowing through the fluid channel 102 adjacent to the at least one set of sensing electrodes. In some embodiments, the set of sensing electrodes are configured to sense one or more properties of a sample fluid in the fluid channel 102. In some embodiments, the at least one set of electrodes 110 include a set of deflecting electrodes configured to provide electrical fields for inducing movement (e.g., deflection) of charged particles (e.g., particles charged by the set of charging electrodes). For example, the electrical fields provided by the set of deflecting electrodes may induce direct movement of the charged particles by providing a potential difference. As another example, the electrical fields provided by the set of deflecting electrodes may be used to control position, rotation and/or acceleration of the charged particles. Additionally, or alternatively, the electrical fields provided by the set of deflecting electrodes may induce electrohydrodynamic flow of the fluid (e.g., when the fluid includes dielectric media). In some embodiments, the set of charging electrodes, the set of sensing electrodes, and/or the set of deflecting electrodes are distinct. In some embodiments, the set of charging electrodes, the set of sensing electrodes, and/or the set of deflecting electrodes include each of the at least one set of electrodes 110 (e.g., the at least one set of electrodes 110 are configured perform each function of the set of charging electrodes, the set of sensing electrodes, and the set of deflecting electrodes).

In some embodiments, the at least one set of electrodes 110 is further configured to sense an alignment between the substrate 112 and the substrate 114. For example, the substrate 112 may include a marker (e.g., a magnetic marker) and the one set of electrodes 110 is configured to sense a positioning of the marker to determine alignment between the substrate 112 and the substrate 114.

In some embodiments, the microfluidic device 100 includes driver/readout circuitry (e.g., driver/readout circuitry 440 described in reference to FIG. 4) electrically coupled to the at least one set of electrodes 110. In some embodiments, the driver/readout circuitry additionally receives electrical signals from the at least one set of electrodes 110 and relays the electrical signals (with or without processing, such as filtering, etc.) to control circuitry (e.g., one or more processors) of, or operationally connected with, the microfluidic device 100. In some embodiments, the driver circuitry is configured to produce electrical signals in the megahertz (MHz) and gigahertz (GHz) frequency ranges. In some embodiments, the frequency of the electrical signals provided to the at least one set of electrodes 110 depends on a type or types of the particles to be analyzed in the microfluidic device 100. In some embodiments, the driver/readout circuitry is arranged on the substrate 112 and/or the substrate 114.

In accordance with some embodiments, the at least one set of electrodes 110 is located in the fluid channel 102 and between the inlet channel 106 and the outlet channel 108. In some embodiments, the at least one set of electrodes 110 is located between the set of piezoelectric components 121 and the set of piezoelectric components 123. In some embodiments, the at least one set of electrodes 110 is located between the set of piezoelectric components 122 and the set of piezoelectric components 123. In some embodiments, each of the at least one set of electrodes 110 is located on a same substrate (e.g., the substrate 114, as illustrated in FIG. 1B). In some embodiments, the at least one set of electrodes 110 is located on different substrates (e.g., a first subset of the at least one set of electrodes 110 is located on the substrate 112 and a second subset of the at least one set of electrodes 110 is located on the substrate 114). In some embodiments, the substrate 112 and/or the substrate 114 includes one or more contacts configured to couple the at least one set of electrodes 110 with the driver/readout circuitry. In some embodiments, a separation distance between the at least one set of electrodes 110 as well as a distance between each electrode of each pair of electrodes is configured based on a type or types of the particles to be analyzed using the microfluidic device 100. In some embodiments, the distance between each subset of the at least one set of electrodes 110 is configured such that only a single particle (e.g., cell) is manipulated with an electrical field at a time. In some embodiments, each particle may pass the vicinity of the at least one set of electrodes 110 for a period between 0.1 milliseconds (ms) and 100 ms. For example, a particle processing rate in the microfluidic device 100 may be between from 100 particles per minute and 1 million particles per minute.

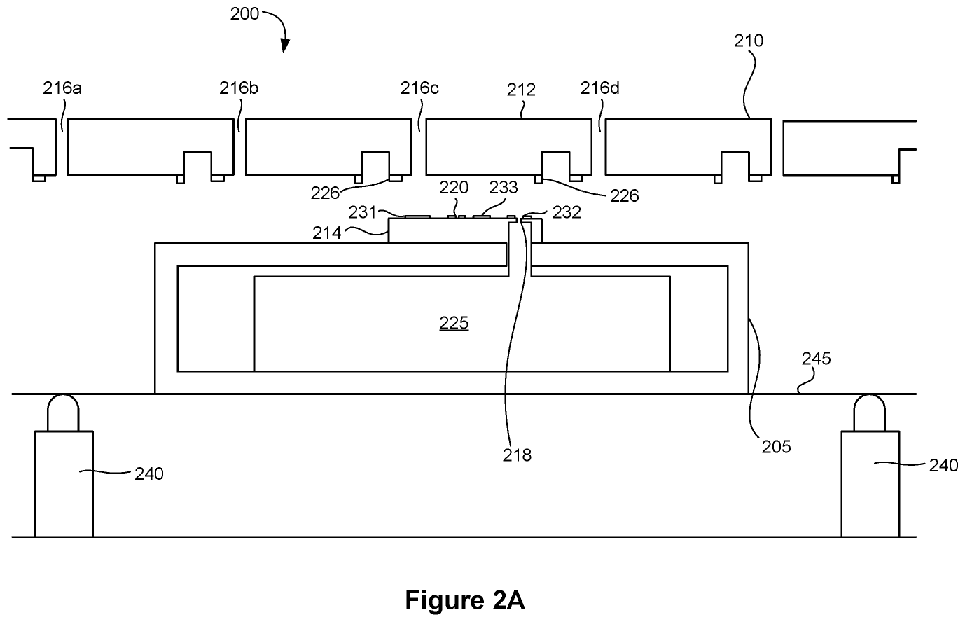

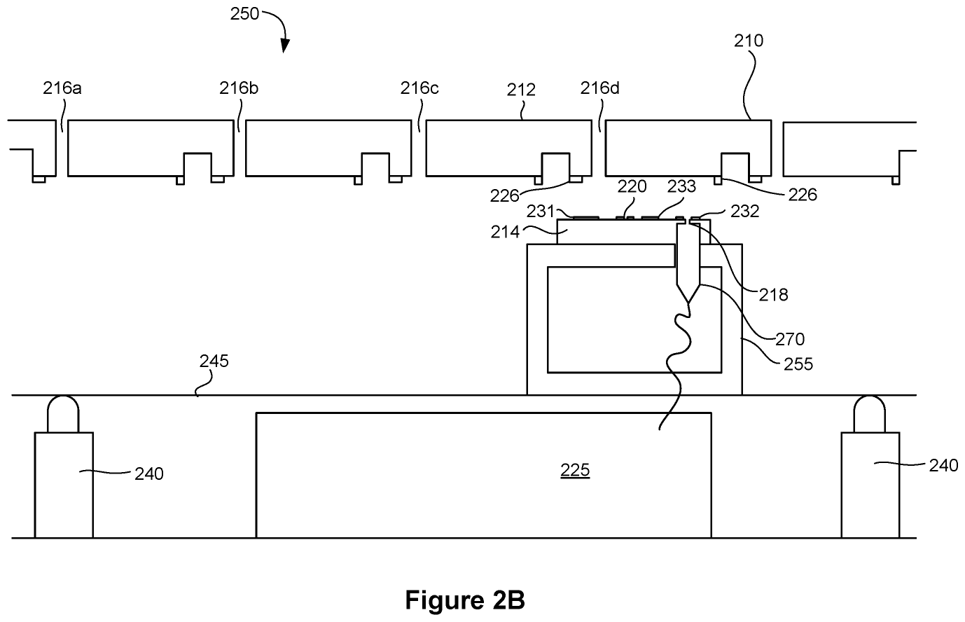

FIG. 2A illustrates a microfluidic device architecture 200 including a reusable component 205 and a disposable component 210 in accordance with some embodiments. FIG. 2B illustrates an alternate microfluidic device architecture 250 including an alternate reusable component 255 and the disposable component 210. The disposable component 210 includes a substrate 212 (e.g., the substrate 112, described in reference to FIGS. 1A-1B). The substrate 212 defines a plurality of inlet ports 216a-216d (e.g., the inlet channel 106, described in reference to FIGS. 1A-1B). The reusable component 205 and the alternate reusable component 255 include a substrate 214 (e.g., the substrate 114, described in reference to FIGS. 1A-1B). The substrate 214 defines an outlet channel 218 (e.g., the outlet channel 108, described in reference to FIGS. 1A-1B). In some embodiments, the substrate 214 defines a plurality of outlet channels 218. In some embodiments, the reusable component 205 and the alternate reusable component 255 further include a set of piezoelectric components 231, a set of piezoelectric components 232, a set of piezoelectric components 233, and at least one set of electrodes 220 (e.g., the set of piezoelectric components 121, the set of piezoelectric components 122, the set of piezoelectric components 123, and the at least one set of electrodes 110, respectively) coupled to a first side of the substrate 214 (e.g., as illustrated in FIGS. 2A-2B).

In some embodiments, the reusable component 205 further includes a reservoir tank 225 coupled to a second side of the substrate 214, opposite of the first side. The reservoir tank 225 is fluidically coupled to the outlet channel 218 and is configured to capture sample fluid (e.g., samples) ejected via the outlet channel 218. In some embodiments, the reservoir tank 225 is fluidically coupled to a plurality of outlet channels (e.g., each outlet channel is coupled to a different component of the reservoir tank). In accordance with some embodiments, the alternate reusable component 255 further includes the reservoir tank 225 fluidically coupled to the outlet channel 218 via a reservoir component 270. The reservoir component 270 is fluidically coupled to the outlet channel 218 and is configured to capture the sample fluid ejected via the outlet channel 218 and direct the sample fluid into the reservoir tank 225. In some embodiments, the reservoir tank 225 includes a plurality of compartments (e.g., and movement of the reusable component 205 and/or the reservoir tank 225 enables different portions of the sample fluid to be collected in different compartments).

In some embodiments, the microfluidic device architecture 200 and/or the alternate microfluidic device architecture 250 includes reservoir control circuitry (e.g., reservoir control circuitry 460, described in reference to FIG. 4) configured to selectively cause different portions of the sample fluid to be ejected into different compartments of the plurality of compartments. In some embodiments, the reservoir control circuitry is the same control circuitry used to control operation of the piezoelectric components and/or the electrodes. For example, the reservoir control circuitry 460, the driver/readout circuitry 440, the actuation circuitry 430, and the processor(s) 402 may be the same component in some embodiments.

As an example, a sensing solution may be collected and stored in a first compartment of the plurality of compartments, a cleaning solution may be collected and stored in a second compartment, a first component of the sample fluid may be collected and stored in a third compartment of the plurality of compartments, and a second component of the sample fluid may be collected and stored in a fourth compartment of the plurality of compartments. For example, the reservoir control circuitry may be configured to adjust a positioning of the reservoir tank 225, the reservoir component 270, and/or the substrate 214 to change which compartment is fluidically coupled to the outlet channel 218 (or which respective compartments are coupled to a plurality of outlet channels) at a given time.

In some embodiments, the at least one set of electrodes 220 includes one or more electrodes (e.g., disposable electrodes) attached to (e.g., mounted on, or embedded in) the disposable component 210. In some embodiments, the disposable electrodes are configured to sense positioning for aligning the disposable component 210 and/or sensing properties of fluid samples during operation of the microfluidic device.

The microfluidic device architecture 200 and the alternate microfluidic device architecture 250 further include a set of actuators 240 (e.g., piezoelectric actuators) coupled to a support 245 in accordance with some embodiments. The support 245 is configured to a support the reusable component 205 (or the alternate reusable component 255) and/or the disposable component 210 (e.g., the support 245 supports the reusable component 205 and the substrate 214, as illustrated in FIG. 2A). The reusable component 205 and the alternate reusable component 255 may also be referred to as supports or support structures for the substrate 214 (e.g., the substrate 214 may be considered as supported by the reusable component 205 or the alternate reusable component 255). In some embodiments, the support 245 is a component of a holder configured to adjust the position of the substrate 212 and/or the substrate 214 (e.g., the holder is configured to align the substrate 212 and the substrate 214). In some embodiments, the holder includes an additional actuator (e.g., a micro actuator) configured to align the substrate 212 and the substrate 214. In some embodiments, the holder includes a support arm configured to hold the substrate 212 and/or the substrate 214 and move one of the substrates into alignment with the other substrate. In some embodiments, the set of actuators 240 is configured to adjust positioning of the support 245 and, thusly, the reusable component 205 (or the alternate reusable component 255) (e.g., as illustrated in FIGS. 2A-2B) and/or the disposable component 210. In some embodiments, the set of actuators 240 includes two piezoelectric actuators (e.g., as illustrated in FIGS. 2A-2B). In some embodiments, each actuator 240 comprises one or more piezoelectric actuators (e.g., one or more multilayer piezoelectric actuators). In some embodiments, each support structure includes a piezoelectric membrane, an actuator piston, and a piston head. In some embodiments, each support structure is configured to actuate in a range between 1 μm and 500 μm. Although FIG. 2A shows the set of actuators 240 coupled to the reusable component 205, in some embodiments, the set of actuators 240 are coupled to the disposable component 210 instead.

In some embodiments, the microfluidic device architecture 200 and the alternate microfluidic device architecture 250 further include a positioning sensor configured to sense the alignment between the substrate 212 and the substrate 214. In some embodiments, the positioning sensor is arranged on the substrate 212 and/or substrate 214 and a marker is arranged on the other substrate. In some embodiments, the positioning sensor comprises at least one of an optical sensor, an electrical sensor, a magnetic sensor, and/or an inertial measurement unit (IMU). In some embodiments, the positioning sensor operates in conjunction with the at least one set of electrodes 220 to sense the alignment between the substrate 212 and the substrate 214. For example, the positioning sensor is configured to sense a signal (or an attenuation of the signal) from the at least one set of electrodes 220).

In some embodiments, the microfluidic device architecture 200 and the alternate microfluidic device architecture 250 further include a bonding layer 226 (e.g., the bonding layer 116, as described in reference to FIGS. 1A-1B). The bonding layer 226 may be coupled to the substrate 212 (e.g., as illustrated in FIGS. 2A-2B) and/or the substrate 214. In some embodiments, the set of actuators 240 is configured to adjust positioning of the support 245 and the reusable component 205 (or the alternate reusable component 255) such that the bonding layer 226 removably couples the substrate 212 and the substrate 214 (e.g., the set of actuators 240 moves the reusable component 205 (or the alternate reusable component 255) up such that the bonding layer 226 on the substrate 212 contacts the substrate 214 (e.g., and forms seal such that a fluid sample in the microfluidic device cannot leave through a space between the bonding layer 226 and the substrate 214)). In this way, while the substrate 212 and the substrate 214 are removably coupled, the substrate 212, the substrate 214, and the bonding layer 226 define a microfluidic channel (e.g., the fluid channel 102, as described in reference to FIGS. 1A-1B).

In some embodiments, the microfluidic device architecture 200 and/or the alternate microfluidic device architecture 250 further includes an additional set of actuators (e.g., piezoelectric actuators) configured move the reusable component 205 and/or the disposable component 210 to align the substrate 212 with the substrate 214. For example, the set of actuators 240 are configured to move the reusable component 205 and the substrate 214 along a first axis (e.g., a vertical axis) and the additional set of actuators is configured to move the reusable component 205 (or the alternate reusable component 255) and the substrate 214 along a second axis (e.g., a horizontal axis). For example, the additional set of actuators may move the reusable component 205 (or the alternate reusable component 255) and the substrate 214 along a first plane (e.g., corresponding to an x-axis) so as to align the substrate 212 and the substrate 214 (e.g., such that the set of piezoelectric components 231 aligns with one of the plurality of inlet ports 216a-216d). While aligned, the set of actuators 240 move the reusable component 205 (or the alternate reusable component 255) and the substrate 214 along a second plane (e.g., corresponding to a y-axis) to couple the substrate 212 and the substrate 214 via the bonding layer 226 to form the microfluidic device.

In some embodiments, the microfluidic device architecture 200 and/or the alternate microfluidic device architecture 250 further includes actuation circuitry (e.g., the actuation circuitry 430 described with respect to FIG. 4). In some embodiments, the set of actuators 240 and/or the additional set of actuators are electrically coupled with the actuation circuitry. In some embodiments, the set of actuators 240 and/or the additional set of actuators comprise one or more linear actuators. In some embodiments, the set of actuators 240 and/or the additional set of actuators comprise one or more pistons. In some embodiments, the set of actuators 240 and/or the additional set of actuators are configured to move the reusable component 205 (or the alternate reusable component 255) and/or the disposable component 210 and the substrate 214 in a range of 50 μm to 1 mm. For example, the set of actuators 240 and/or the additional set of actuators have a precision in the range of 1 μm to 10 μm (e.g., 3 μm).

FIG. 2A illustrates the reusable component 205 including the reservoir tank 225, where the reservoir tank 225 is configured to move with the reusable component 205 and the substrate 214, in accordance with some embodiments. FIG. 2B illustrates alternate reusable component 255 and reservoir component 270 configured to move with the substrate 214, while the reservoir tank 225 does not move and remains below the alternate reusable component 255 in accordance with some embodiments. For example, the reservoir component 270 comprises a flexible tubing fluidically coupled to the outlet channel 218 and the reservoir tank 225 such that the reservoir tank 225 maintains a fluidic connection with the outlet channel 218 as the alternate reusable component 255 and the substrate 214 is moved relative to the reservoir tank 225.

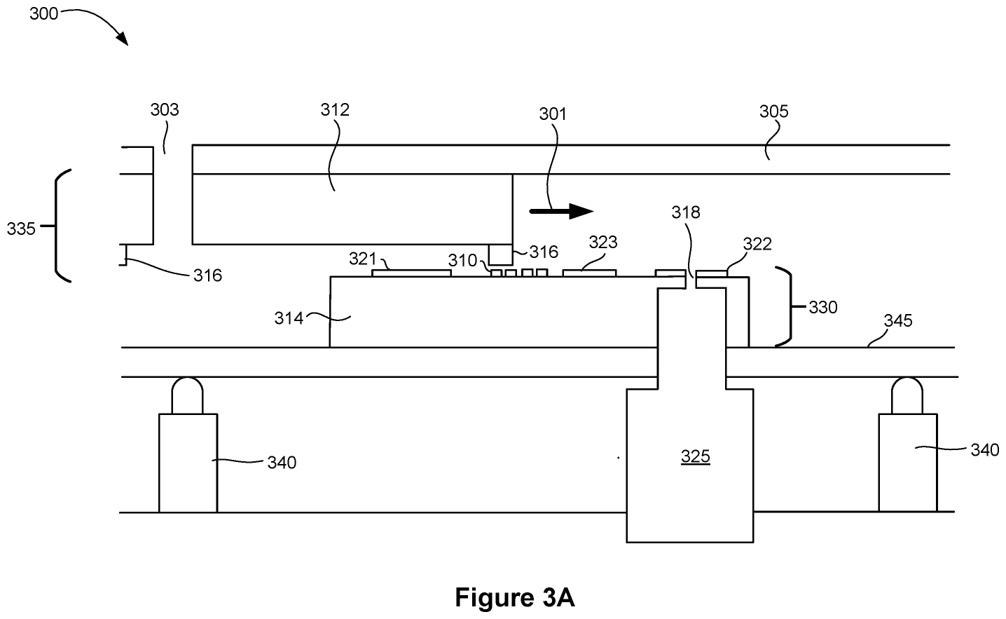

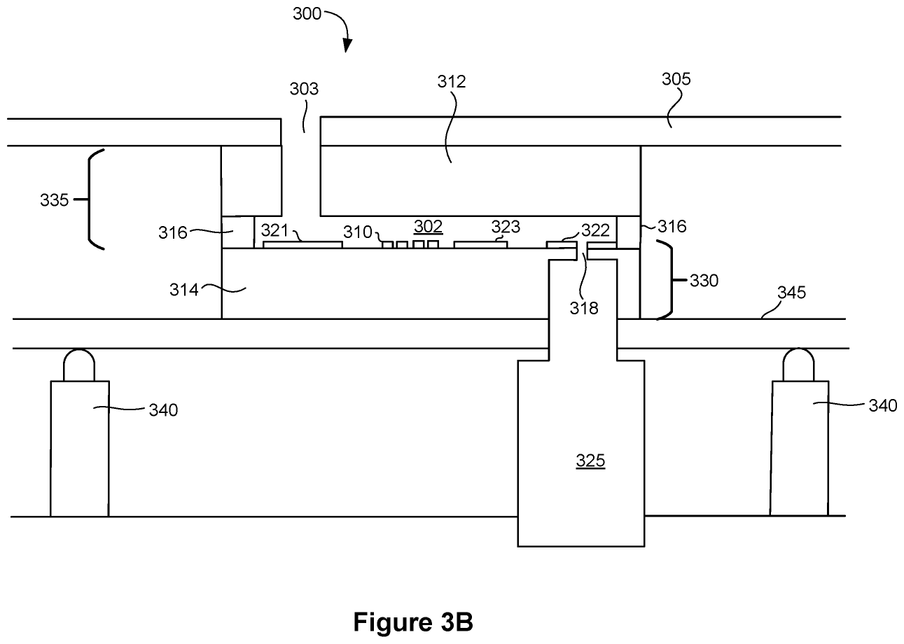

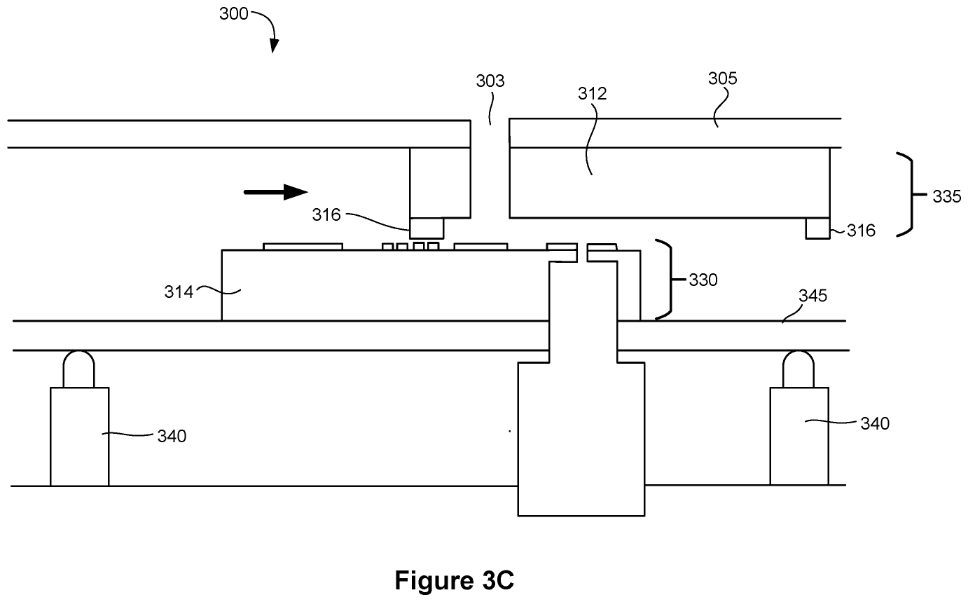

FIGS. 3A-3C illustrate a method of operating a microfluidic device 300 in accordance with some embodiments. FIGS. 3A-3C illustrate the microfluidic device 300 including a reusable component 330 and a disposable component 335. The disposable component 335 includes a substrate 312 (e.g., the substrate 112 and/or the substrate 212) which defines an inlet channel 303 (e.g., the inlet channel 106). In some embodiments, the disposable component 335 further includes a support structure. The reusable component 330 includes a substrate 314 (e.g., the substrate 114 and/or the substrate 214). The substrate 314 defines an outlet channel 318 (e.g., an instance of the outlet channel 108 and/or the outlet channel 218). In some embodiments, the substrate 314 defines a plurality of outlet channels. In some embodiments, the reusable component 330 further includes a set of piezoelectric components 321, a set of piezoelectric components 322, a set of piezoelectric components 323, and at least one set of electrodes 310 (e.g., the set of piezoelectric components 121 and/or the set of piezoelectric components 231, the set of piezoelectric components 122 and/or the set of piezoelectric components 232, the set of piezoelectric components 123 and/or the set of piezoelectric components 233, and the at least one set of electrodes 110 and/or the at least one set of electrodes 220, respectively) coupled to a first side of the substrate 314 (e.g., as illustrated in FIGS. 3A-3C).

In some embodiments, the microfluidic device 300 further includes a bonding layer 316 (e.g., the bonding layer 116 and/or the bonding layer 226) that couples to the substrate 312 and/or the substrate 314. In some embodiments, the bonding layer 316 removably couples the substrate 312 and the substrate 314. While the substrate 312 and the substrate 314 are removably coupled, the substrate 312, the substrate 314, and the bonding layer 316 define a microfluidic channel (e.g., the fluid channel 102, as described in reference to FIGS. 1A-1B). In some embodiments, the reusable component 330 further includes a reservoir tank 325 coupled to a second side of the substrate 314, opposite of the first side. The reservoir tank 325 is coupled to the outlet channel 318 and is configured to capture fluid ejected via the outlet channel 318. In some embodiments, the reservoir tank 325 includes a plurality of compartments and the microfluidic device 300 includes control circuitry for selecting an active compartment (e.g., based on sample analysis).

The microfluidic device 300 further includes a set of actuators 340 (e.g., the set of actuators 240) coupled to a support 345 (e.g., an instance of the support 245) in accordance with some embodiments. The support 345 is configured to a support the reusable component 330 and/or the disposable component 335 (e.g., the support 345 supports the reusable component 330 and the substrate 314, as illustrated in FIGS. 3A-3C). The substrate 312 in FIGS. 3A-3C is coupled to a support 305 in accordance with some embodiments. In some embodiments, the supports 305 and 345 are components of a holder that is configured to position the substrate 312 and/or the substrate 314 (e.g., configured to align the substrate 312 and the substrate 314). In some embodiments, the set of actuators 340 is configured to adjust positioning of the support 345 and the reusable component 330. In some embodiments, the set of actuators 340 includes two piezoelectric actuators (e.g., as illustrated in FIGS. 3A-3C).

In some embodiments, the microfluidic device 300 further includes an additional set of actuators (e.g., as described above with reference to FIGS. 2A-2B). The additional set of actuators are configured move the reusable component 330 and/or at least a portion of the disposable component 335 as to align the substrate 312 with the substrate 314. For example, the set of actuators 340 is configured to move the reusable component 330 and the substrate 314 along a first axis (e.g., a vertical axis), and the additional set of actuators is configured to move the substrate 312 of the disposable component 335 along a second axis (e.g., a horizontal axis). For example, the additional set of actuators moves the substrate 312 along a first plane (e.g., corresponding to an x-axis) to align the substrate 312 and the substrate 314 (e.g., such that the inlet channel 303 aligns with the inlet channel 303 and/or the inlet channel 303 aligns with the set of piezoelectric components 321, as illustrated in FIG. 3B). While aligned, the set of actuators 340 move the reusable component 330 and the substrate 314 along a second plane (e.g., corresponding to a y-axis) to couple the substrate 312 and the substrate 314 via the bonding layer 316 to form the fluid channel 302.

In some embodiments, the microfluidic device 300 further includes actuation circuitry (e.g., the actuation circuitry 430 described with respect to FIG. 4). In some embodiments, the set of actuators 340 and/or the additional set of actuators are electrically coupled with the actuation circuitry. In some embodiments, the actuation circuitry controls the set of actuators 340 and/or the additional set of actuators to align the substrate 312 and the substrate 314. In some embodiments, the microfluidic device 300 further includes a positioning sensor (e.g., any of the positioning sensors described herein) configured to sense an alignment between the substrate 312 and the substrate 314. In some embodiments, the positioning sensor is arranged on the substrate 312 and/or substrate 314. In some embodiments, the positioning sensor operates in conjunction with the at least one set of electrodes 310 to sense the alignment between the substrate 312 and the substrate 314 (e.g., the positioning sensor senses a signal (or an attenuation of the signal) from the at least one set of electrodes 310).

FIG. 3A illustrates the microfluidic device 300 aligning the substrate 312 with the substrate 314 (e.g., as illustrated by the arrow 301) in accordance with some embodiments. For example, the additional set of actuators moves the substrate 312 and/or the substrate 312 horizontally (e.g., to the right, as illustrated in FIG. 3A) until the substrate 312 aligns with the substrate 314. In accordance with a determination that the substrate 312 is aligned with the substrate 314, the set of actuators 340 move the reusable component 330 vertically (e.g., upward, as illustrated in FIGS. 3A-3B) to removably couple the substrate 312 and the substrate 314 via the bonding layer 316. FIG. 3B illustrates the substrate 312 and the substrate 314 being coupled (e.g., using the set of actuators 340) to a form the fluid channel 302 (e.g., the fluid channel 102) defined by the substrate 312, the substrate 314, and the bonding layer 316. In some embodiments, the reusable component 330 is arranged on a moving stage coupled to the additional set of actuators and/or the set of actuators 340.

In some embodiments, after coupling the substrate 312 and the substrate 314, a first washing cycle begins. The first washing cycle may include inserting a first washing fluid (e.g., a saline solution) into the fluid channel 302 via the inlet channel 303. The washing cycle lasts a first period of time (e.g., a range between 10 seconds and 10 minutes), and, after the first period of time has passed, the first washing fluid is ejected from the fluid channel 302 via the outlet channel 318 to complete the first washing cycle.

In some embodiments, in response to the completing the first washing cycle, the microfluidic device 300 begins a sensing cycle. In some embodiments, the microfluidic device 300 begins a sensing cycle in after the substrate 312 and the substrate 314 are coupled (e.g., skipping the first washing cycle). The sensing cycle may include inserting a sensing solution into the fluid channel 302 via the inlet channel 303. In some embodiments, the sensing solution is a same fluid as the sample fluid (e.g., the sensing solution is the sample fluid without sample particles). The set of piezoelectric components 322 may actuate to adjust a flow rate of the sensing solution and eject portions of the sensing solution from the fluid channel 302. The microfluidic device 300 senses a background signature (e.g., one or more parameters) of the fluid channel 302 via measurements detected at the at least one set of electrodes 310. In some embodiments, sensing the background signature of the fluid channel 302 comprises sensing one or more parameters of the sensing solution. In accordance with a determination that the background signature of the fluid channel 302 fails to satisfy at least one signature criterion, the sensing fluid is ejected from the fluid channel 302 via the outlet channel 318. In some embodiments, in accordance with the determination that the background signature of the fluid channel 302 fails to satisfy the at least one signature criterion, another washing cycle is performed. In some embodiments, in accordance with the determination that the background signature of the fluid channel 302 fails to satisfy the at least one signature criterion (e.g., even after a subsequent washing), the substrate 312 and the substrate 314 are then decoupled and realigned.

In accordance with a determination that the background signature of the fluid channel 302 satisfies the at least one signature criterion, a sampling cycle begins. The sampling cycle includes inserting a sample fluid (e.g., cells, molecules, other particles) into the fluid channel 302 via the inlet channel 303. In some embodiments, the set of piezoelectric components 321, the set of piezoelectric components 322, and/or the set of piezoelectric components 323 are configured to manipulate movement of the sample fluid in the fluid channel 302 from the inlet channel 303 toward the outlet channel 318 (e.g., as described in reference to FIGS. 1A-1B). In some embodiments, the set of piezoelectric components 321 mix the sample fluid and/or dissociate particles of the sample fluid. In some embodiments, as the sample fluid passes adjacent to the at least one set of electrodes 310 and/or the set of piezoelectric components 323, the at least one set of electrodes 310 and/or the set of piezoelectric components 323 manipulate respective orientations/locations of particles of the sample fluid. In some embodiments, the at least one set of electrodes 310 charge the particles of the sample fluid. In some embodiments, the at least one set of electrodes 310 and/or the set of piezoelectric components 323 sense one or more properties of the sample fluid and/or the particles of the sample fluid. For example, a charging portion of the at least one set of electrodes 310 applies a first electric field the particles to charge the particles, a manipulating portion of the at least one set of electrodes 310 applies a second electric field to the particles to manipulate a location of the particles in the fluid channel 302, and a sensing portion of the at least one set of electrodes 310 applies a third electric field to the particles to measure an impedance of the particles.

In some embodiments, in accordance with an analysis of the one or more properties of the sample fluid and/or the particles of the sample fluid, the microfluidic device 300 (e.g., control circuitry of the microfluidic device 300) adjusts a flow rate of the fluidic sample via the set of piezoelectric components 321, the set of piezoelectric components 322, and/or the set of piezoelectric components 323. In some embodiments, adjusting the flow rate comprises separating components of the sample fluid. For example, the components of the fluidic sample are separated by applying the second electric field to the particles to manipulate a location of the particles in the fluid channel 302. In some embodiments, control circuitry (e.g., driver/readout circuitry 440 and actuation circuitry 430, described in reference to FIG. 4) of the microfluidic device 300 controls operation of the set of piezoelectric components 321, the set of piezoelectric components 322, and/or the set of piezoelectric components 323 and/or the at least one set of electrodes 310 based on an analysis of the one or more properties of the sample fluid.

After sensing the one or more properties of the sample fluid, the sample fluid is ejected into the reservoir tank 325 via the outlet channel 318. In some embodiments, the sample fluid is ejected into one of the plurality of compartments of the reservoir tank based on the one or more properties of the sample fluid. In some embodiments, a first portion of the sample fluid is ejected into a first compartment of the plurality of compartments of the reservoir tank and a second portion of the sample fluid is ejected into a second compartment of the plurality of compartments of the reservoir tank, based on one or more properties of the first portion and/or one or more properties of the second portion, respectively (e.g., the one or more properties of the first portion and the one or more properties of the second portion sensed by the at least one set of electrodes 310). In some embodiments, the one of the plurality of compartments allows particular portions of the sample fluid to be inserted back into the fluid channel 302, via the inlet channel 303, to start a new sampling cycle with the particular portions. In some embodiments, an intermediate washing cycle (e.g., similar to the first washing cycle) is performed before a sample fluid is inserted back into the fluid channel 302. As an example, the sample fluid is inserted into the fluid channel 302, via the inlet channel 303 and based on the one or more properties of the first portion and the one or more properties of the second portion, the first portion is ejected into the first compartment, and the second portion is ejected into a second compartment. In this example, the intermediate washing cycle is performed and then the first portion is inserted back into the fluid channel 302, via the inlet channel 303. In accordance with some embodiments, based on one or more properties of a first sub-portion of the first portion and one or more properties of a second sub-portion of the first portion, the first sub-portion is ejected into a third compartment of the plurality of compartments, and the second sub-portion is ejected into a fourth compartment of the plurality of compartments.

In accordance with a determination that the sampling cycle is completed (e.g., all or substantial portion of the sample fluid has been ejected from the fluid channel 302), a second washing cycle begins. The second washing cycle may include inserting a second washing fluid (e.g., a saline solution) into the fluid channel 302 via the inlet channel 303. The second washing cycle lasts a second period of time, and, after the second period of time has passed, the second washing fluid is ejected from the fluid channel 302 via the outlet channel 318 (or outlet channels) to complete the second washing cycle.

In some embodiments, in accordance with completing the second washing cycle, the microfluidic device 300 decouples the substrate 312 and the substrate 314. FIG. 3C illustrates the substrate 312 and the substrate 314 having been decoupled. For example, the set of actuators 340 may move the reusable component 330 vertically (e.g., downward, as illustrated in FIGS. 3B-3C) to decouple the substrate 312 and the substrate 314. In some embodiments, the bonding layer 316 remains coupled to one of the substrates (e.g., the substrate 312 as illustrated in FIG. 3C). In some embodiments, the additional set of actuators then move the substrate 312 horizontally (e.g., to the right, as illustrated in FIG. 3C).

FIG. 4 is a block diagram illustrating example components of a microfluidic device 400 in accordance with some embodiments. The example components include electrical components for flow control of particles (e.g., the sample fluid) in a fluid channel (e.g., the fluid channel 102 and/or the fluid channel 302). In some embodiments, the microfluidic device 400 (e.g., the microfluidic device 100 and/or the microfluidic device 300) includes one or more processors 402 (or other types of control circuitry) and memory 404. In some embodiments, the memory 404 includes instructions for execution by the one or more processors 402. In some embodiments, the stored instructions include instructions for providing actuation signals to piezoelectric components 401 (e.g., the set of piezoelectric components 121, the set of piezoelectric components 231, the set of piezoelectric components 321, the set of piezoelectric components 122, the set of piezoelectric components 232, the set of piezoelectric components 322, the set of piezoelectric components 123, the set of piezoelectric components 233, and/or the set of piezoelectric components 323) and/or piezoelectric actuators 431 (e.g., the set of actuators 240, the set of actuators 340, and/or the additional sets of actuators described herein). In some embodiments, the actuation signals for the piezoelectric components 401 are configurable such that each of the piezoelectric components 401 create oscillations at a different frequency from a frequency of oscillations of another of the piezoelectric components 401. In some embodiments, the actuation signals for the piezoelectric actuators 431 are configurable to align a first substrate (e.g., the substrate 212 or the substrate 312) and a second substrate (e.g., the substrate 214 or the substrate 314). For example, one or more of the set of piezoelectric components 121, the set of piezoelectric components 122, and the set of piezoelectric components 123 may operate at a frequency in the range between 0.5 kilohertz (KHz) and 100 KHz, for example, based on desired flow rates, and/or manipulation operations. In some embodiments, the stored instructions include instructions for providing actuation signals to the at least one set of electrodes 110 (and/or the at least one set of electrodes 220 and/or the at least one set of electrodes 310), e.g., for charging particles flowing through the fluid channel 102 so that the particles can be manipulated with an electrical field and/or for detecting particle properties.

In some embodiments, the device also includes an electrical interface 406 coupled with the one or more processors 402 and the memory 404. For example, the electrical interface 406 may include one or more electrical ports, electrical buses, and/or electric contacts/vias. In some embodiments, the device further includes actuation circuitry 430, which is coupled to the sets of piezoelectric components and the sets of piezoelectric actuators. The actuation circuitry 430 is configured to send electrical signals to the sets of piezoelectric components and the sets of piezoelectric actuators to initiate movement/actuation of the sets of piezoelectric components and the sets of piezoelectric actuators.

In some embodiments, the device further includes driver/readout circuitry 440, which is coupled to the electrodes 405 (e.g., the at least one set of electrodes 110, the at least one set of electrodes 220, and/or the at least one set of electrodes 310). The driver/readout circuitry 440 is configured to send electrical signals to the electrodes 405 to generate an electrical field using the electrodes 405 for charging particles of the sample fluid flowing through the fluid channel 102 and/or manipulating locations of the particles of the sample fluid flowing through the fluid channel 102. In some embodiments, the device further includes measurement/analysis circuitry 450, which is coupled to the electrodes 452 (e.g., the at least one set of electrodes 110, the at least one set of electrodes 220, and/or the at least one set of electrodes 310). The measurement/analysis circuitry 450 receives electrical signals from the electrodes 452 and provides the electrical signals (e.g., with or without processing) to the one or more processors 402 (or other control circuitry) via the electrical interface 406. In some embodiments, the device further includes reservoir control circuitry 460, which is coupled to reservoir tank 465 (e.g., the reservoir tank 225 and/or the reservoir tank 325). The reservoir control circuitry 460 is configured to send electrical signals to the reservoir tank 465 to selectively cause different portions of the sample fluid to be ejected into different compartments of the reservoir tank 465.

In some embodiments, the various components shown in FIG. 4 are combined such that a single component performs the functionality of two or more of the components shown in FIG. 4. For example, the electrodes 405 and the electrodes 452 may be a single set of electrodes. As another example, the processors 402, the actuation circuitry 430, the measurement/analysis circuitry 450, the driver/readout circuitry 440 and/or the reservoir control circuitry may be combined into a single controller.

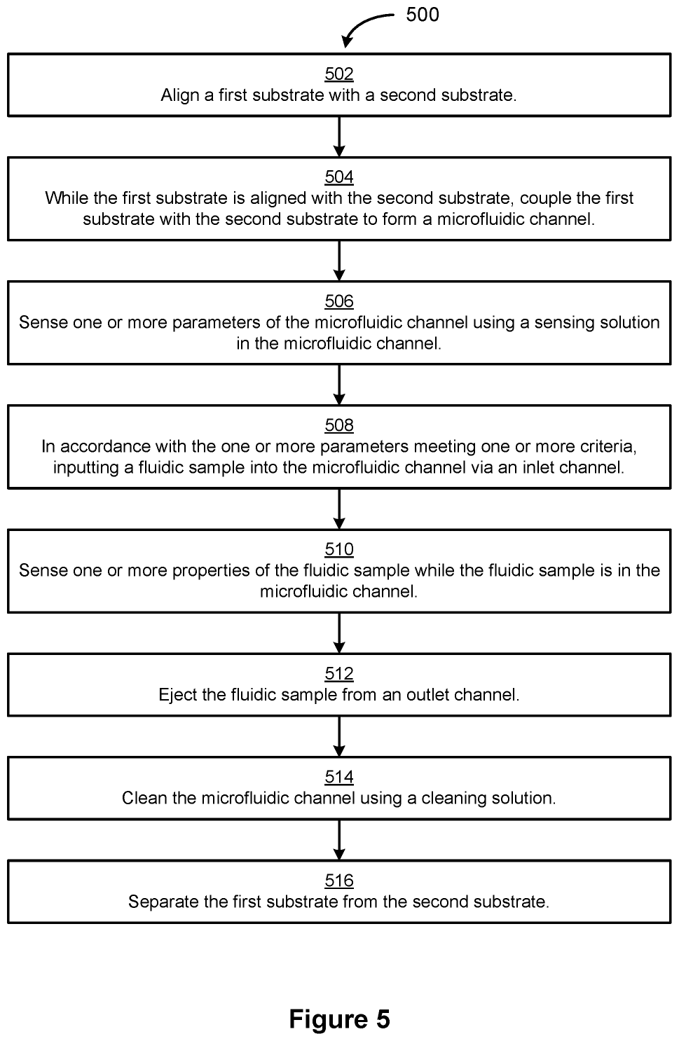

FIG. 5 is a flow diagram illustrating a method 500 of operating a microfluidic device (e.g., the microfluidic device 100 and/or the microfluidic device 300) in accordance with some embodiments. The method 500 includes (502) aligning a first substrate (e.g., the substrate 112, the substrate 212, and/or the substrate 312) with a second substrate (e.g., the substrate 114, the substrate 214, and/or the substrate 314). In some embodiments, the aligning is performed by at least one set of piezoelectric actuators (e.g., the set actuators 240, the set of actuators 340, and the additional set of actuators) in accordance with control signals (e.g., from actuation circuitry 430). In some embodiments, the control signals are based on data from one or more electrodes (e.g., the electrodes 452) and/or position sensors.

The method 500 further includes (504), while the first substrate is aligned with the second substrate, coupling the first substrate with the second substrate to form a microfluidic channel (e.g., the fluid channel 102 and/or the fluid channel 302). In some embodiments, a polymer (e.g., the bonding layer 116, the bonding layer 226, and/or the bonding layer 316) couples the first substrate with the second substrate and further forms the microfluidic channel.

The method 500 further includes (506) sensing one or more parameters (e.g., the background signature) of the microfluidic channel using a sensing solution in the microfluidic channel. In some embodiments, the one or more parameters are detected using at least one set of electrodes (e.g., the at least one set of electrodes 110, the at least one set of electrodes 220, and/or the at least one set of electrodes 310) and/or a set of piezoelectric components (e.g., the set of piezoelectric components 123, the set of piezoelectric components 233, and/or the set of piezoelectric components 323). In some embodiments, the microfluidic channel is cleaned prior to using the sensing solution.

The method 500 further includes (508), in accordance with the one or more parameters meeting one or more criteria, inputting a fluidic sample (e.g., the sample fluid) into the microfluidic channel via an inlet channel (e.g., the inlet channel 106, one of the plurality of inlet ports 216a-216d, and/or the inlet channel 303). In some embodiments, in accordance with the one or more parameters not meeting the one or more criteria, one or more remedial actions are performed (e.g., as described in more detail below).

The method 500 further includes (510) sensing one or more properties of the fluidic sample (e.g., the impedance of the particles of the sample fluid) while the fluidic sample is in the microfluidic channel. In some embodiments, the sensing of the one or more properties is performed by the at least one set of electrodes and/or the set of piezoelectric components.

The method 500 further includes (512) ejecting the fluidic sample from an outlet channel (e.g., the outlet channel 108, the outlet channel 218, and/or the outlet channel 318). In some embodiments, the fluidic sample is ejected into a reservoir tank (e.g., the reservoir tank 225 and/or the reservoir tank 325) via the outlet channel.

The method 500 further includes (514) cleaning the microfluidic channel using a cleaning solution (e.g., the saline solution).

The method 500 further includes (516) separating the first substrate from the second substrate. In some embodiments, the separating is performed by the at least one set of piezoelectric actuators, as described previously in reference to FIGS. 2A-3C.

In light of the above disclosure certain embodiments are described below.

(A1) In accordance with some embodiments, a microfluidic device includes: (i) a first substrate (e.g., the substrate 112, the substrate 212, the substrate 312); (ii) a second substrate (e.g., the substrate 114, the substrate 214, and/or the substrate 314); (iii) a first set of electrodes (e.g., the at least one set of electrodes 110, the at least one set of electrodes 220, and/or the at least one set of electrodes 310); (iv) a set of piezoelectric components (e.g., the set of piezoelectric components 121, the set of piezoelectric components 231, the set of piezoelectric components 321, the set of piezoelectric components 122, the set of piezoelectric components 232, the set of piezoelectric components 322, the set of piezoelectric components 123, the set of piezoelectric components 233, and/or the set of piezoelectric components 323); (v) a support (e.g., the support 245 and/or the support 345); (vi) a set of piezoelectric actuators (e.g., the set of actuators 240 and/or the set of actuators 340) coupled to the support; (vii) a polymer (e.g., the bonding layer 116, the bonding layer 226, and/or the bonding layer 316). The first set of electrodes and the set of piezoelectric components are coupled to a first surface of the second substrate. The support is configured to support at least one of the first substrate and the second substrate. The set of piezoelectric actuators is configured to adjust positioning of the support. The polymer is adapted to removably couple the first and second substrates, where a microfluidic channel (e.g., the fluid channel 102 and/or the fluid channel 302) is formed between the first and second substrates (and the polymer) while the first and second substrates are coupled by the polymer.

In some embodiments, an inlet channel is formed through a thickness of the first substrate. In some embodiments, an outlet channel is formed through a thickness of the second substrate. In some embodiments, the first substrate is a single-use substrate (e.g., a disposable substrate). In some embodiments, the second substrate is a reusable substrate. For example, the second substrate is configured to be used multiple times with different first substrates. In some embodiments, the support is a component of a holder configured to position the first substrate and/or the second substrate (e.g., configured to align the first substrate and the second substrate). In some embodiments, the holder includes an additional actuator (e.g., a micro actuator) configured to align the first substrate and the second substrate. In some embodiments, the holder includes a support arm configured to hold a substrate and move the substrate into alignment with another substrate. For example, the holder may include the support 305, the support 345, and one or more actuators for moving the support 345 (e.g., moving the support 345 along a horizontal axis) and/or the set of actuators 340. That is, the components 330 and 335 may be attached to the holder such that the holder can align and couple/decouple the components. In some embodiments, the polymer is adapted to form a fluidic seal for the microfluidic channel while coupling the first and second substrates. In some embodiments, the polymer is adapted to detach from the first substrate in accordance with a mechanical force applied to the polymer being reduced. In some embodiments, the piezoelectric elements (e.g., components and/or actuators) described herein are composed of lead zirconate titanate (PZT and/or any of the BKT-BMT-BFO set. For example, KNN such as (K0.5Na0.5)NbO3, BKT such as (Bi0.5K0.5)TiO3, BMT such as Bi(Mg0.5Ti0.5)O3, BFO such as BiFeO3, BNT such as (Bi0.5Na0.5)TiO3, and/or BT such as BaTiO3.

(A2) In some embodiments of A1, the microfluidic device further includes a second set of piezoelectric actuators (e.g., the additional set of piezoelectric actuators described in reference to FIGS. 2A-3C). The second set of piezoelectric actuators are configured move at least one of the first (e.g., as illustrated in FIGS. 3A-3C) and second (e.g., as illustrated in FIGS. 2A-2B) substrates so as to align the first substrate with the second substrate. For example, the set of piezoelectric actuators are configured to move the second substrate along a first axis (e.g., a vertical axis) and the additional actuator is configured to move the second substrate along a second axis (e.g., a horizontal axis). As an example, the set of piezoelectric actuators consists of one piezoelectric actuator. As another example, the set of piezoelectric actuators comprises two or more piezoelectric actuators. For example, the one or more actuators may move the first and/or second substrate along a first plane (e.g., corresponding to an x-axis) so as to align the first and second substrates; and, while aligned, a second set of actuators may move the first and/or second substrate along a second plane (e.g., corresponding to a y-axis) so as to connect the first and second substrates to form the microfluidic channel. In some embodiments, the one or more actuators comprises one or more pistons. In some embodiments, a reservoir tank is connected to the second substrate and moved with the second substrate. In some embodiments, the microfluidic device includes a reservoir component, and the reservoir component is not moved when the one or more actuators move the first and/or second substrate. For example, the reservoir component may be coupled to the outlet channel via a flexible tubing so that the reservoir component maintains a fluidic connection with the second substrate as the second substrate is moved.

(A3) In some embodiments of A1-A2, the first set of electrodes comprises one or more sensing electrodes configured to sense one or more properties of a particle (e.g., in the sample fluid) in the microfluidic channel. For example, the first set of electrodes comprises a pair of sensing electrodes configured to analyze subjects (e.g., samples, cells, or particles). In some embodiments, the set of electrodes includes one or more electrodes configured to provide actuation signals to at least a subset of the set of piezoelectric components. In some embodiments, the set of electrodes is configured to perform one or more of: applying an electromagnetic field to the microfluidic channel, sensing one or more properties of a fluidic sample in the microfluidic channel, and sensing an alignment between the first substrate and the second substrate.

(A4) In some embodiments of A1-A3, the microfluidic device further includes a second set of electrodes coupled to the first substrate (e.g., the at least one set of electrodes 110, as described in reference to FIGS. 1A-1B). In some embodiments, the second set of electrodes comprises one or more sensing electrodes. In some embodiments, a first electrode of the set of electrodes is paired with a second electrode of the second set of electrodes. In some embodiments, the set of electrodes and/or the second set of electrodes are configured to apply one or more electrical fields to a fluid in the microfluidic channel. For example, the first and second electrodes are configured to apply an electrical field to a fluid in the microfluidic channel. In some embodiments, the first substrate includes one or more contacts configured to couple the second set of electrodes with control circuitry (e.g., control circuitry arranged on the second substrate). In some embodiments, the second set of electrodes is configured to perform one or more of: applying an electromagnetic field to the microfluidic channel, sensing one or more properties of a fluidic sample in the microfluidic channel, and sensing an alignment between the first substrate and the second substrate.

(A5) In some embodiments of A1-A4, the microfluidic device further a positioning sensor (e.g., the positioning sensor described in reference to FIGS. 2A-3C) configured to sense an alignment between the first substrate and the second substrate. In some embodiments, the positioning sensor comprises an optical sensor, an electrical sensor, a magnetic sensor, and/or an inertial measurement unit (IMU). In some embodiments, the positioning sensor operates in conjunction with one or more electrodes to sense an alignment of the substrates (e.g., the positioning sensor senses a signal (or an attenuation of the signal) from the first set of electrodes).

(A6) In some embodiments of A1-A5, the polymer is configured to temporarily attach the first substrate to the second substrate (e.g., as described in reference to FIGS. 1A-3C). In some embodiments, the polymer is configured to connect the first and second substrates while a given set of conditions are present. For example, the polymer may be a sticky polymer adapted to temporarily stick to one of the first and second substrates. In some embodiments, the polymer is configured to connect the first and second substrates while a particular pressure is applied. For example, the polymer is bonded to the second substrate and adapted to attach to the first substrate while being pressed into the first substrate. In some embodiments, the polymer attaches to the first substrate while an electrical and/or mechanical force is present on the microfluidic device. In some embodiments, the polymer is adapted to attach to the first and second substrates while subject to a set of conditions and the polymer is adapted to detach from at least the first substrate while not subjected to the set of conditions. For example, the set of conditions may include pressure in a certain range being applied to the polymer. In some embodiments the polymer is a programmable adhesive. An example of programmable adhesive is silicotungstic acid (SiW)-complexed R32 protein hydrogels.

(A7) In some embodiments of A1-A6 the microfluidic device further includes a reservoir tank (e.g., the reservoir tank 225, the alternate reservoir tank 275, and/or the reservoir tank 325) coupled to an outlet channel (e.g., the outlet channel 108, the outlet channel 218, and/or the outlet channel 318) of the microfluidic channel. The reservoir tank is configured to capture fluid (e.g., the sample fluid) ejected from microfluidic channel via the outlet channel.

(A8) In some embodiments of A1-A7, the reservoir tank comprises a plurality of compartments (e.g., the plurality of compartments, as described in reference to FIGS. 2A-3C). The microfluidic device further comprising control circuitry (e.g., the actuation circuitry 430, the driver/readout circuitry 440, and/or the reservoir control circuitry 460) configured to selectively cause different portions of a fluidic sample to be ejected into different compartments of the plurality of compartments. In some embodiments, the reservoir tank includes multiple compartments and is configured to store separate materials in separate compartments. For example, a sensing solution may be collected and stored in a first compartment, a cleaning solution may be collected and stored in a second compartment, a first component of a fluidic sample may be collected and stored in a third compartment, and a second component of the fluidic sample may be collected and stored in a fourth compartment. For example, the control circuitry adjusts a positioning of the reservoir tank and/or the second substrate to change which compartment is coupled to the outlet channel. In some embodiments, control circuitry is electrically coupled to the set of piezoelectric actuators and/or the set of electrodes and configured to govern operation of the set of piezoelectric components and/or the set of electrodes so as to control outlet to the compartment of reservoir based on analyzing the data.

(A9) In some embodiments of A1-A8, the polymer is detachably coupled to a first side of the second substrate and the set of piezoelectric actuators are coupled to a second side of the second substrate, the second side opposite the first side (e.g., as illustrated in FIGS. 2A-3C). In some embodiments, the set of actuators are configured to move the second substrate to couple the second substrate with the first substrate. In some embodiments, the set of actuators are configured to move the first substrate to couple the first substrate with the second substrate. In some embodiments, the set of actuators comprises one or more piezoelectric actuators (e.g., one or more multilayer piezoelectric actuators). In some embodiments, the set of actuators is communicatively coupled with control circuitry of the microfluidic device. In some embodiments, the set of actuators are configured to move the second substrate in a range of 10 μm to 500 μm. In some embodiments, the set of actuators comprises one or more linear actuators. For example, the set of actuators may have an accuracy in the range of 0.1 μm to 50 μm (e.g., 3 μm).

(A10) In some embodiments of A1-A9, the set of piezoelectric components comprises one or more piezoelectric actuators. In some embodiments, the set of piezoelectric actuators are configured to control a flow rate of the microfluidic channel. In some embodiments, the set of piezoelectric actuators comprise a first subset of actuators at an inlet of the microfluidic device (e.g., configured to dissociate particles of a fluidic sample), a second subset of actuators along a length of the microfluidic channel (e.g., configured to rotate, sort, and/or move particles of the fluidic sample), and a third subset of actuators at an outlet of the microfluidic device (e.g., configured to selectively eject particles of the fluidic sample). In some embodiments, the set of piezoelectric components comprises one or more piezoelectric thin films. In some embodiments, the set of piezoelectric components are composed of lead zirconate titanate (PZT).

(A11) In some embodiments of A1-A10, the microfluidic channel includes an outlet (e.g., the outlet channel 108). The set of piezoelectric components comprises one or more piezoelectric actuators arranged adjacent to the outlet (e.g., as illustrated in FIGS. 1A-3C). In some embodiments, the one or more piezoelectric actuators are configured to eject a portion of a fluid out of the microfluidic channel via the outlet. In some embodiments, the fluid is adapted to be ejected out of the microfluidic channel via the hole of the outlet. For example, the outlet and particles in the fluid are on a same order of magnitude. In some embodiments, the one or more piezoelectric actuators are arranged to at least partially enclose the outlet. In some embodiments, the one or more piezoelectric actuators are arranged on a membrane. For example, the membrane may be composed of a thin layer of substrate (e.g., thickness in the range of 1 μm to 5 μm).

(A12) In some embodiments of A1-A11, the microfluidic device further includes control circuitry (e.g., the electrical components described in reference to FIG. 4) electrically coupled to the set of piezoelectric components and/or the first set of electrodes and configured to govern operation of the set of piezoelectric and/or the first set of electrodes. In some embodiments, the control circuitry is configured to provide activation signals to the set of electrodes to selectively charge particles flowing through the microfluidic channel. In some embodiments, the control circuitry comprises a microcontroller. In some embodiments, the control circuitry is configured to govern one or more of: sensing of the microfluidic channel (e.g., a sensing time and/or sensing current), cleaning of the microfluidic channel (e.g., cleaning timing, cleaning solution flow rate, and/or an amount of cleaning solution), and movement of the first substrate and/or the second substrate. In some embodiments, the microfluidic device includes communication circuitry (e.g., configured for wired and/or wireless communication) and the control circuitry governs operation of the communication circuitry.

(A13) In some embodiments of A1-12, the first substrate is composed of glass. In some embodiments, the first substrate is composed of a transparent or clear material (e.g., glass or plastic). In some embodiments, the first substrate includes one or more sense electrodes (e.g., one or more sense probes). In some embodiments, the first substrate comprises a plurality of partial microfluidic channels, each partial microfluidic channel a having a separate inlet channel. For example, the first substrate includes a number of disposable partial channel components. In this example, each partial microfluidic channel may be aligned and connected to the second substrate in turn to perform a plurality of sensing operations. In some embodiments, a composition of the first substrate is selected based on a use of the microfluidic device (e.g., based on a type of fluid to be used in the microfluidic device).

(A14) In some embodiments of A1-A13, the second substrate is composed of silicon (e.g., a silicon-on-insulator (SOI) semiconductor). For example, the substrate may be a silicon on insulator (SOI) substrate. In some embodiments, the second substrate (e.g., the substrate 314) includes, or is attached, or otherwise coupled to, a support substrate (e.g., the substrate 345). In some embodiments, a composition of the second substrate is selected based on a use of the microfluidic device (e.g., based on a type of fluid to be used in the microfluidic device).

(B1) In accordance with some embodiments a method, comprises: (i) aligning a first substrate (e.g., the substrate 112, the substrate 212, the substrate 312) with a second substrate (e.g., the substrate 114, the substrate 214, and/or the substrate 314); (ii) while the first substrate is aligned with the second substrate, coupling the first substrate with the second substrate to form a microfluidic channel (e.g., the fluid channel 102 and/or the fluid channel 302); (iii) sensing one or more parameters of the microfluidic channel (e.g., the background signature) using a sensing solution in the microfluidic channel; (iv) in accordance with the one or more parameters meeting one or more criteria, inputting a fluidic sample (e.g., the sample fluid) into the microfluidic channel via an inlet channel (e.g., the inlet channel 106, one of the plurality of inlet ports 216a-216d, and/or the inlet channel 303); (v) sensing one or more properties of the fluidic sample (e.g., the impedance of the particles of the sample fluid) while the fluidic sample is in the microfluidic channel; (vi) ejecting the fluidic sample from an outlet channel (e.g., the outlet channel 108, the outlet channel 218, and/or the outlet channel 318); (vii) cleaning the microfluidic channel using a cleaning solution (e.g., the saline solution described in reference to FIGS. 3A-3C); and (viii) separating the first substrate from the second substrate.

In some embodiments, sensing the one or more properties of the fluidic sample comprise sensing an impedance of the fluidic sample. In some embodiments, separating the first substrate from the second substrate comprises moving the substrates apart along a first axis and then moving at least one of the substrates away along a second axis. In some embodiments, the alignment of the first substrate and the second substrate is based on data from one or more sensors (e.g., image sensors, magnetic sensors, electric sensors, and/or other types of sensors). In some embodiments, the sensing solution comprises a same fluid as the fluidic sample (e.g., the sensing solution is the fluidic sample without the sample). In some embodiments, sensing one or more parameters of the microfluidic channel comprises sensing one or more parameters of the sensing solution. In some embodiments, cleaning the microfluidic channel comprises inputting a cleaning solution at the inlet channel and subsequently ejecting the cleaning solution at the outlet channel. In some embodiments, the cleaning solution is ejected at one or more of a plurality of outlet channels (e.g., ejected into one or more corresponding compartments of a reservoir component).

(B2) In some embodiments of B1, the method further comprises obtaining positioning data (e.g., via the positioning sensor described in reference to FIGS. 2A-3C) for the first and second substrates, where the first substrate and the second substrate are aligned by control circuitry of the microfluidic device (e.g., the electrical components described in reference to FIG. 4) in accordance with the positioning data. For example, the control circuitry aligns the substrates based on optical, electrical, and/or magnetic markers.

(B3) In some embodiments of B1-B2, the method further comprises, in accordance with the one or more parameters not meeting the one or more criteria: (i) performing one or more remedial actions (e.g., the intermediate washing cycle, described in reference to FIGS. 3A-3C); and (ii) after performing the one or more remedial actions, re-sensing the one or more parameters of the microfluidic channel. In some embodiments, the one or more remedial actions comprises one or more of re-aligning the first substrate with the second substrate; and inputting a cleaning solution into the microfluidic channel. In some embodiments, the cleaning solution comprises a saline solution.

(B4) In some embodiments of B1-B3, the one or more remedial actions comprise de-coupling and realigning the first and second substrates. In some embodiments, a first substrate is aligned with a second substrate (e.g., using a holder component) and, while the first substrate is aligned with the second substrate, the first substrate is coupled with the second substrate (e.g., via a polymer) to form a microfluidic channel. In some embodiments, one or more parameters of the microfluidic channel are sensed using a sensing solution in the microfluidic channel. In some embodiments, in accordance with the one or more parameters meeting one or more criteria, a fluidic sample is input into the microfluidic channel and one or more properties of the fluidic sample are sensed (e.g., via a set of electrodes). In some embodiments, in accordance with the one or more parameters not meeting the one or more criteria, the first and second substrates are de-coupled and re-aligned.

(B5) In some embodiments of B1-B4, different portions of the fluidic sample are output to different compartments (e.g., the plurality of compartments) of a reservoir tank (e.g., the reservoir tank 225, the alternate reservoir tank 275, and/or the reservoir tank 325) based on respective sensed properties (e.g., as described in reference to FIGS. 2A-3C). In some embodiments, the method further comprises re-inputting at least a portion of the fluidic sample from the reservoir tank into the microfluidic channel. In some embodiments, the microfluidic channel is cleaned/washed before re-inputting the at least a portion of the fluidic sample (e.g., the microfluidic channel is cleaned after each use). In some embodiments, a first portion of the fluidic sample is separated from a second portion of the fluidic channel (e.g., a first component of the fluidic sample is separated from a second component of the fluidic sample using one or more electromagnetic fields), and the first portion is stored separately from the second portion. In some embodiments, the first portion is re-input and re-sensed with the second portion. In this way, a purity of the fluidic sample may be improved.

(B6) In some embodiments of B1-B5, the method further comprises, in accordance with the sensed one or more properties of the fluidic sample, adjusting, via a set of piezoelectric actuators (e.g., the set of piezoelectric components 121, the set of piezoelectric components 231, the set of piezoelectric components 321, the set of piezoelectric components 122, the set of piezoelectric components 232, the set of piezoelectric components 322, the set of piezoelectric components 123, the set of piezoelectric components 233, and/or the set of piezoelectric components 323), a flow rate of the fluidic sample (e.g., the laminar flow described in reference to FIGS. 1 and 3A-3C). In some embodiments, adjusting the flow rate comprises separating components of the fluidic sample. For example, the components of the fluidic sample are separated using one or more electromagnetic fields. In some embodiments, control circuitry of the microfluidic device controls operation of the set of piezoelectric actuators based on analysis of the sensed properties of the fluidic sample.

(B7) In some embodiments of B1-B6, the first substrate is removably coupled with the second substrate via a polymer (e.g., the bonding layer 116, the bonding layer 226, and/or the bonding layer 316). For example, the second substrate includes a polymer component that is adapted to stick/bond to the first substrate. In some embodiments, the polymer is a silicone polymer. For example, the polymer may be polydimethylsiloxane (PDMS). In some embodiments, the polymer forms a fluidic seal for the microfluidic channel while coupling the first substrate to the second substrate.

(B8) In some embodiments, of B1-B7, the method further comprises any of the features described above with respect to A1-A14.

It will be understood that, although the terms first, second, etc. may be used herein to describe various elements, these elements should not be limited by these terms. These terms are only used to distinguish one element from another. For example, a first array could be termed a second array, and, similarly, a second array could be termed a first array, without departing from the scope of the various described embodiments. The first array and the second array are both arrays, but they are not the same array unless explicitly specified as such.

The terminology used in the description of the embodiments herein is for the purpose of describing particular embodiments only and is not intended to be limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the principles and the various described embodiments with various modifications as are suited to the particular use contemplated.

What is claimed is:

1. A microfluidic device, comprising:
a first substrate;
a second substrate;
a first set of electrodes and a set of piezoelectric components coupled to a first surface of the second substrate;
a support configured to support at least one of the first substrate and the second substrate;
a set of piezoelectric actuators coupled to the support and configured to adjust positioning of the support; and
a polymer adapted to removably couple the first and second substrates, wherein a microfluidic channel is formed between the first and second substrates while the first and second substrates are coupled by the polymer.

2. The microfluidic device of claim 1, further comprising a second set of piezoelectric actuators configured move at least one of the first and second substrates so as to align the first substrate with the second substrate.

3. The microfluidic device of claim 1, wherein the first set of electrodes comprises one or more sensing electrodes configured to sense one or more properties of a particle in the microfluidic channel.

4. The microfluidic device of claim 1, further comprising a second set of electrodes coupled to the first substrate.

5. The microfluidic device of claim 1, further comprising a positioning sensor configured to sense an alignment between the first substrate and the second substrate.

6. The microfluidic device of claim 1, wherein the polymer is configured to temporarily attach the first substrate to the second substrate.

7. The microfluidic device of claim 1, further comprising a reservoir tank coupled to an outlet channel of the microfluidic channel, the reservoir tank configured to capture fluid ejected from microfluidic channel via the outlet channel.

8. The microfluidic device of claim 7, wherein the reservoir tank comprises a plurality of compartments; and
the microfluidic device further comprising control circuitry configured to selectively cause different portions of a fluidic sample to be ejected into different compartments of the plurality of compartments.

9. The microfluidic device of claim 1, wherein the polymer is detachably coupled to a first side of the second substrate and the set of piezoelectric actuators are coupled to a second side of the second substrate, the second side opposite the first side.

10. The microfluidic device of claim 1, wherein the set of piezoelectric components comprises a one or more piezoelectric actuators.

11. The microfluidic device of claim 1, wherein the microfluidic channel includes an outlet, and wherein the set of piezoelectric components comprises one or more piezoelectric actuators arranged adjacent to the outlet.

12. The microfluidic device of claim 1, further comprising control circuitry electrically coupled to the set of piezoelectric components and/or the first set of electrodes and configured to govern operation of the set of piezoelectric and/or the first set of electrodes.

13. The microfluidic device of claim 1, wherein the first substrate is composed of glass.

14. The microfluidic device of claim 1, wherein the second substrate is composed of silicon.

15. A method of operating a microfluidic device, the method comprising:
aligning a first substrate with a second substrate;
while the first substrate is aligned with the second substrate, coupling the first substrate with the second substrate to form a microfluidic channel;
sensing one or more parameters of the microfluidic channel using a sensing solution in the microfluidic channel;
in accordance with the one or more parameters meeting one or more criteria, inputting a fluidic sample into the microfluidic channel via an inlet channel;
sensing one or more properties of the fluidic sample while the fluidic sample is in the microfluidic channel;
ejecting the fluidic sample from an outlet channel;
cleaning the microfluidic channel using a cleaning solution; and
separating the first substrate from the second substrate.

16. The method of claim 15, further comprising:
obtaining positioning data for the first and second substrates, wherein the first substrate and the second substrate are aligned by control circuitry of the microfluidic device in accordance with the positioning data.

17. The method of claim 15, further comprising, in accordance with the one or more parameters not meeting the one or more criteria:
performing one or more remedial actions; and
after performing the one or more remedial actions, re-sensing the one or more parameters of the microfluidic channel.

18. The method of claim 17, wherein the one or more remedial actions comprise de-coupling and realigning the first and second substrates.

19. The method of claim 15, wherein different portions of the fluidic sample are output to different compartments of a reservoir tank based on respective sensed properties.

20. The method of claim 15, further comprising, in accordance with the sensed one or more properties of the fluidic sample, adjusting, via a set of piezoelectric actuators, a flow rate of the fluidic sample.

21. The method of claim 15, wherein the first substrate is removably coupled with the second substrate via a polymer.
